(19) United States
(12) Patent Application Publication
(10) Pub. No.: US 2009/0211393 A1
(43) Pub. Date: Aug. 27, 2009

(54) Adjustable command cable terminal

(76) Inventor: Paolo Paparoni, Sao Bernado Do Campo (BR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 11/989,048

(22) PCT Filed: May 12, 2005
(86) PCT No.: PCT/BR2005/000080

§ 371 Date: Oct. 2, 2008

(30) Foreign Application Priority Data
Aug. 25, 2004 (BR) PI0403739-1

(51) Int. Cl. F16C 1/22

(52) U.S. Cl. 74/502.6

(57) ABSTRACT

An adjustable command cable terminal is disclosed as can be used for example in the automobile industry. By turning glove central support and shoe move radially within opening formed in internal terminal for locking or releasing shaft. Radial movement of central support and shoe is achieved by the inner geometry of glove which has variable inner diameter including section with wider diameter for length adjustment of shaft, section with progressively reduced diameter for quick closing, section of an Archimedes-curve and section with small diameter for the locked stated. Central support is urged outwards against the inner geometry of glove by springs. Inner surface of internal terminal and other surface of shaft have corresponding threads.

The object of the invention is a fixing system for command cable terminals and, specifically, a new fixing device for command cable terminals, be them simple or double action (push-pull), enabling to regulate and fix said cables to the corresponding command elements by means of a simple manual rotation movement.

### DESCRIPTION OF THE RELATED ART

In the current state of the art, there are various applications of flexible cables to precisely transmit command forces and movements from the transmitting mechanical element to the receiving mechanical element, especially in cases where the localization of said elements does not allow direct connection between them.

In the automobile industry, such command transmission cables are traditionally used to transmit e. g. commands from the clutch pedal to the clutch itself, or to send switch gear commands to the gear box. The system is especially indicated in cases where there are obstructions in the connection path between the transmitting element and the receiving element. A single action (pull) or double action (push-pull) transmitting cable is constituted by an especially manufactured internal flexible cable which, in case of single action, just enables the transmission of traction forces and, in case of double action, may transmit traction and compression forces. An external cover conduit or sheath, which is also flexible, contains said internal cable, sliding within it with minimum clearance. The constant linear measurements of both elements alongside the cable axis determines the precision for movement transmissions.

Generally, both ends of the internal cable have terminals allowing its hinged connection to the transmitting element and the receiving element for the movement and both ends of the external cover have fixing means to the supports of the corresponding terminals.

Due to its own structure and under the action of working efforts, as well as the ageing of materials due to temperature fluctuations, the internal cable and the external cover are subject to small plastic deformations changing the length of said elements, and a periodical correction of the length of the cable becomes required. Also, the relative distance between the mechanical elements connected by the cable is subject to the effects of tolerances from the whole chain of components and supports existing between said elements and therefore cannot be precisely predetermined.

The effects of the above referenced factors require the presence of a system allowing to regulate the length of the cable and its fixing to the corresponding terminal elements at the time of assembly and during the working life of said cable to compensate length variations while in use.

Various kinds of transmission cables which length can be regulated are used for this purpose, including elements fixing the correct length after regulation. In a widely used regulation and fixing system, the end of the cable is fixed to a screwed shaft and the internally screwed terminal element is turned over the screw of said shaft, axially displacing it and thus allowing to regulate the length of the cable. The correct position, once reached, is fixed by means of a counterscrew.

Regulation and fixing as described above offer difficulties, since they must frequently be made in badly accessible layouts. Screw adjustment and especially counterscrew pressure require in these cases the use of two overlaid tools and the access of both hands of the adjuster within the limited available space make such regulation very complex, time-taking and expensive. The safety of the operation is also prejudiced by the difficulty to guarantee the correct pressure torque for the counterscrew under the described conditions.

There are currently various devices developed to avoid the above inconveniences, in which the regulation and fixing of the final length of the cable is made by means of axial, or axial and radial conjugated movements, which however generally require the use of both hands and frequently demand the use of supporting tools.

### SUMMARY OF THE INVENTION

Due to the above considerations, there is the requirement to develop an adjustment and fixing system for cable lengths to allow to connect them to the corresponding mechanical command elements quickly and property, thus offering guarantees against the possibility of failure of said fixing under any working condition.

The solution presented herein is a simple, efficient and low-cost fixing device which, within less than half turn of the fixing device, allows to release the cable, define its length and fix it again.

With the device as presented herein, the operation requires only one adjuster's hand and no help of any kind of tool is required, thus allowing to manipulate the device even in hardly accessed places.

The device as presented by this invention is constituted by an externally cylindrical glove which, when turned by the hand of the adjuster, allows to fix or loose the cable terminal shaft to be introduced within its center.

The internal axial hole of the glove presents variable radius opening which, in a given path, makes use of an Archimedes curve type profile. Said opening is in sliding contact with a radially displaceable pressure actuator, so that the actuator gets closer or more distant from the cable terminal shaft with a movement which is not proportional to the rotation angle of the glove.

Said variable radius opening of the internal axial hole of the glove is constituted by various successive sectors, with the following functions:
a first scape zone for the cable terminal shaft guarantees the widest possible opening of the internal hole, allowing the free axial displacement of the cable terminal shaft. In this stage, the correct position of the cable is automatically adjusted, thus corresponding to the point where, at the neutral command position, cable axial forces are null;
a second quick approximation zone for the blocking organ, in which the space for the free movement of said shaft is even reduced;
a third zone is a strongly incremented pressure slope, to quickly increase the blocking force of the cable terminal shaft.

The quick reduction of the radius of the internal hole of the glove, as obtained in this zone by means of an Archimedes curve, exerts force multiplying action to guarantee strong shaft retention pressure;
a final blocking zone with minimum pressure increment to guarantee the irreversibility of the final pressure and compensate manufacturing tolerances for the various components. The final blocking pressure is also a function of a small elastic deformation of the elastoplastic material of the glove and pressure actuator.

The whole sequence above is made in less than half turn of the glove of the fixing device, thus allowing quick fixing to the adjuster.

To assure cable blocking, the external surface of the end of the is terminal shaft of the same cable, as well as the corresponding internal surface of the device receiving said shaft are formed by multiple annular threads with large retention capacity. Therefore, in the fixing position of the device, the threaded surface of the shaft is engaged by the threads of the corresponding device surface.

Besides the above described controlled locking, the device as presented herein offers visual and auditive safety locking, assured by a curved elastic element located externally to the device, which is locked by the adjuster in a radial pin integrated to the terminal body.

In summary, the advantages of the device object of the present invention are the following:
the fixing device is simple, compact, efficient and low-cost;
in less than half turn of the glove, the fixing device allows to release the cable, define its length and fix it again;
it allows to quickly regulate and fix the cable by using one single hand of the operator and with a simple manual rotation movement;
no help of any kind of tool is required, thus allowing to manipulate the device even in hardly accessed layouts.

The result is a more simple, quicker and safer operation for the assembly and regulation of the command cable system, thus causing considerable reduction in operation costs. One of the most useful practical results is that the system allows for regulation in small spaces more safely than the previous ones.

### DESCRIPTION OF FIGURES

The features, purpose and advantages of the new fixing device for command cable terminals as presented by the invention become clearer from the detailed disclosure of the attached drawings, which represent illustratively but not limitatively the embodiment of a fixing system for command cables, in which:

FIG. 1 is a perspective view of the new fixing device set for command cable terminals as presented by this invention;

FIG. 2 is a perspective view of the external glove of the new device;

FIG. 3 is a perspective view of the internal terminal of the same device;

FIG. 4 shows the pressure actuator of the same device;

FIG. 5 shows the pressure actuator as assembled over the internal terminal;

FIG. 6 is a lengthwise section of the device, showing its operation;

FIG. 7 is a schematic representation of the profile of the internal axial hole of the glove.

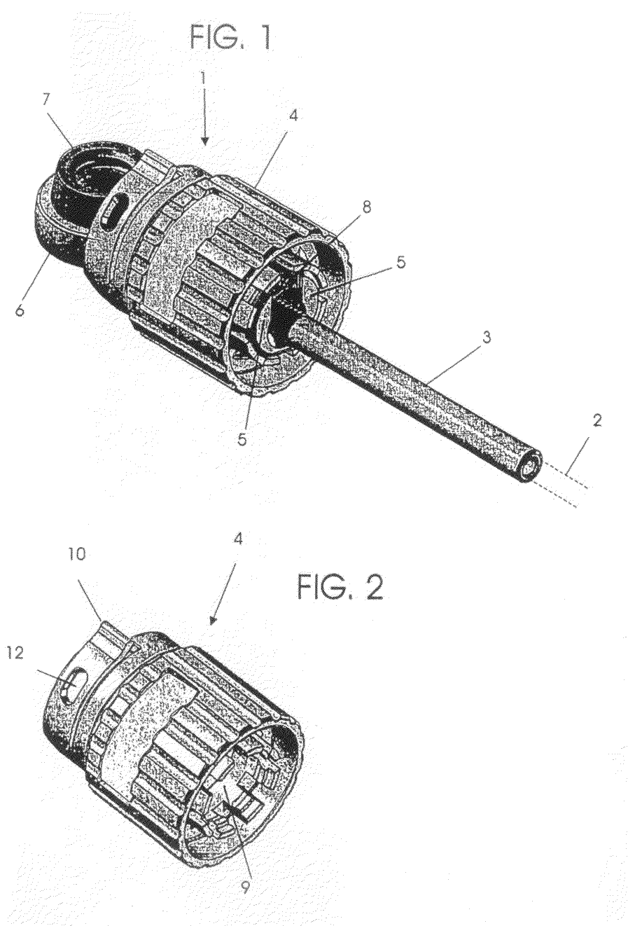

More specifically referring to the drawings, FIG. 1 shows the fixing device set 1 which, while in operation, transmits the movement and command force from the transmitting element (not shown in the drawing) to the flexible internal cable 2, fixed to the shaft 3 and, through this cable, to the receiving command element on the other end of the cable 2.

Upon the assembly of the command system, or when a readjustment of the cable size is required, the fixing device set 1 has the purpose to leave free movement to the shaft 3, solidary to the flexible cable 2. After the cable 2 length is readjusted, the shaft 3, solidary to the cable 2, should again be fixed to the fixing device 1.

In the same FIG. 1, the components of the fixing device set 1 can be located: the shaft 3, the glove 4; the internal terminal 5 with its annular head 6 solidary to it, and the spherical bush 7, which is contained within said annular head 6. The central hole of the spherical bush 7 is hinged to the command transmitting element, not shown in the drawings.

The end of the pressure actuator 8 can also be seen on FIG. 1, radially sliding within the tearing of the internal terminal 5 tigthening or loosing the shaft 3 and thus causing the fixing or free movement of the cable 2.

FIG. 2 shows the glove 4 of the fixing device 1. The grooves of its external surface can be noticed, thus facilitating the application of hand force by the adjuster.

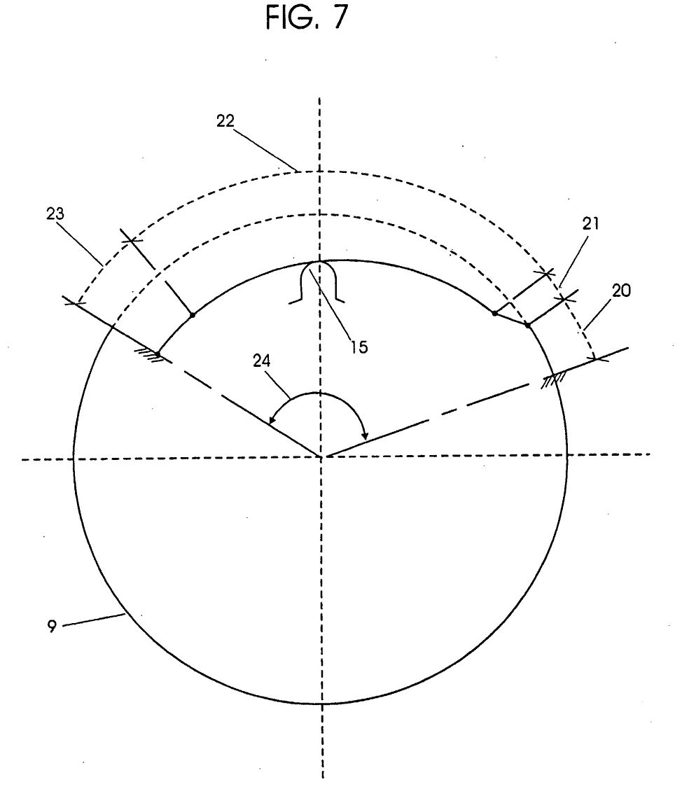

The internal axial hole 9 of said glove, which remains in contact with the pressure actuator 8, presents circular profile with variable radius which, in a given path, is defined by an Archimedes curve type. Therefore, the radius of said internal axial hole 9 is non-uniformly reduced more and more, thus creating angular zones which purposes were already previously explained in this description and will be shown in a scheme further below on FIG. 7.

The rotation of the glove 4, activated by the hand of the adjuster, determines the radial position of the pressure actuator 8, which gets closer or far from the shaft 3, depending on the sense and the rotation angle of said glove 4.

On the final angular tightening zone, or on the fixing zone between the pressure actuator 8 and the shaft 3, the curvature radius of the Archimedes curve is such to guarantee the irreversibility of the final tightening, thus guaranteeing to fix the command cable 2.

Besides this guarantee, the glove 4 has a safety lock 10 solidary to said glove. This lock is applied by the adjuster, by fitting the pin 11 of the internal terminal 5 to the oblong hole 12 of the safety lock 10.

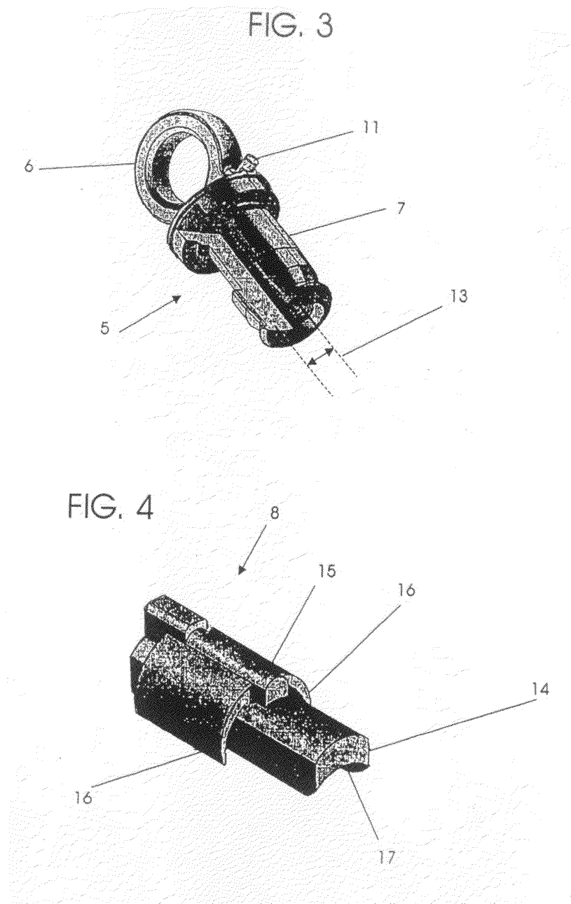

FIG. 3 shows the internal terminal 5 with its annular head 6 and cylindrical body 7. Said cylindrical body has a lengthwise opening 13 with parallel walls, between which the shoe 14 of the pressure actuator 8 fits and radially slides as a function of the request received by turning the glove 4.

The pressure actuator 8 as shown by FIG. 4, which is made of highly resistant elastoplastic material, is constituted by the shoe 14, which applies the fixing pressure over the shaft 3, the central support 15 and both wing-shaped springs 16. The pressure exerted by the internal profile of the glove 4 over the central support 15 of the pressure actuator 8 is in contrast with the action of both springs 16 which, by opening in contact with the cylindrical body 7 of the internal terminal 5, force the pressure actuator 8 to a wider opened position.

In the final blocking position, the locking force of the pressure actuator 8 over the shaft 3 is exerted by the lengthwise concave surface 17 of the shoe 14.

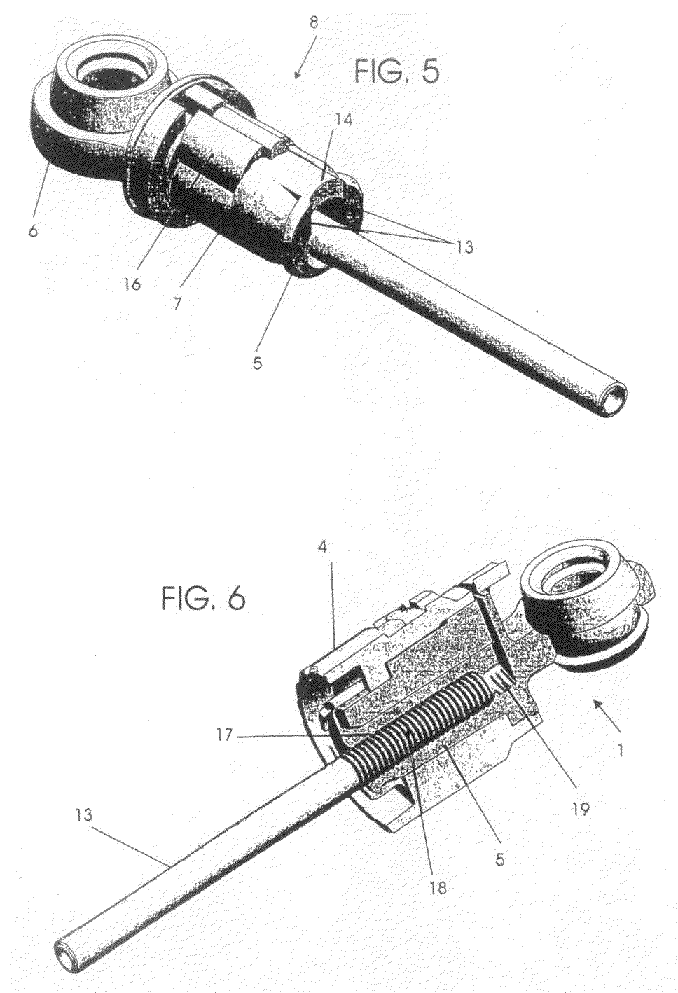

The set of pressure actuator 8 as assembled on the internal terminal 5 is shown by FIG. 5, showing the shoe 14 of the pressure actuator 8 fitted sliding to the lengthwise opening 13 of the internal terminal 5. The same FIG. 5 also shows one of the two springs 16 in contact with the cylindrical body 7 of the internal terminal 5, in opposition to the closing movement of the shoe 14.

The lengthwise section of FIG. 6 shows the device set 1 in its final fixing position to the shaft 3, solidary to the cable 2. We can observe in this figure that, to assure efficient locking of the shaft 3 to the fixing device 1, the whole external diameter 18 of the final path of the shaft 3 and the internal semidiameter 19 of the internal terminal 5 are formed by multiple annular threads with large retention capacity.

Therefore, in the fixing position of the device (1), the thread surface of the shaft (3) is engaged by the threads (19) of the internal terminal (5).

FIG. 7 schematically shows the profile of the internal axial hole 9 of the glove 4. Said profile is always in contact with the central support 15 of the pressure actuator 8. Any variation in the radius of said profile radially moves the actuator 8, getting it closer or far from the shaft 3 and applying over it the fixing force of the cable 2.

To reach the operation of the fixing device as presented by this invention, the active part of the profile of the internal axial hole 9 is constituted by successive sectors with variable radius, as shown by FIG. 7, with different purposes:
a first sector 20 with larger radius of the hole 9 provides the shaft with more freeness, allowing to adjust the length of the cable 2;
a second sector 21 is a part of the profile presenting quick radius reduction to get the actuator 8 near to the shaft 3;
in a third sector 22, the profile is given by an Archimedes curve which, progressively reducing the radius, quickly increases the blocking force of the terminal shaft 3 of the cable 2;
a fourth sector 23 constitutes a blocking region, with minimum reduction of the radius and a minimum increment of shaft 3 tightening, thus guaranteeing irreversible operation.

The whole adjustment and fixing operation of the command cable 2 is effected within the space of the four above described sectors and the corresponding rotation angle 24 of the glove 4. This rotation angle, as we can see from the scheme on FIG. 7, is less than half the internal axial hole 9, i. e. a half-turn of the glove 4.

To release the shaft 3 and the cable 2 solidary to it, the adjuster releases the safety lock 10 of the pin 11 and applies to the glove 4 corresponding rotation inversely to the applied sense to lock the shaft 3.

We can also notice that the fixing and regulation system of this invention allows the use of transmission cables with fixed length, which are more simple, economical and safer.

From the above explanations, it becomes clear that the new features presented by this invention make it a lot easier to assemble and regulate the whole mechanical command transmission system by means of cables, especially under difficult access conditions of the elements linked by the cable, offer better safety to the operation of the command system and allow considerable reduction of operation times and costs.

We can understand that the presented solution may suffer amendments and variations in its way of realization, as long as it does not go beyond the object of the invention, as expressed in the following claims.

1. “Fixing Device for Command Cable Terminals” which allows to regulate and fix the length of single or double-action flexible cables, used for the transmission of command s from an emitting mechanical element to a receiving mechanical element, in which said fixing device is constituted by a glove, inside which an internal terminal and a pressure actuator are assembled which, due to the rotation of the glove, radially slides within a lengthwise opening with parallel walls of the internal terminal, so to lock or release a shaft which is solidary to the cable, providing to fix or release said command cable depending on the rotation sense of the glove, manually actuated by the operator.

2. “Fixing Device for Command Cable Terminals” of claim 1, wherein the central support of the pressure actuator is always kept in contact with the internal axial hole of said glove by the action of the two wing-shaped springs over the cylindrical body of the internal terminal; and consequently the distance between the concave surface of the shoe of the pressure actuator and the shaft is determined by the ray of the internal axial hole of the glove.

3. “Fixing Device for Command Cable Terminals” of claim 1, wherein the internal hole of the glove presents a variable ray profile, including an Archimedes curve-like portion, due to the rotation angle of the glove; and consequently causes variations off the free distance between the shoe and the shaft; and said variations of the ray of the internal hole determine various angular sectors with different functions, alongside the rotation of said glove.

4. “Fixing Device for Command Cable Terminals” of claim 1, wherein a first angular sector of the internal hole of the glove presents the lower ray, providing a free zone for the shaft solidary to the cable and consequently allowing automatic adjustment of the correct position of the cable.

5. “Fixing Device for Command Cable Terminals” of claim 1, wherein a second angular sector of the internal hole provides a quick closing zone of the shoe to the shaft, progressively reducing the freeness of said shaft.

6. “Fixing Device for Command Cable Terminals” of claim 1, wherein a third angular sector of the internal hole constitutes a high slope tightening slide, which quickly increases the blocking force of the shoe over the shaft.

7. “Fixing Device for Command Cable Terminals” of claim, wherein the final blocking angular sector of the internal hole has a minimum ray variation and a minimum tightening increment, so to guarantee irreversible final tightening and compensate manufacturing tolerances for the various components.

8. “Fixing Device for Command Cable Terminals” of claim 4, wherein the whole sequence is performed in less than half turn of the glove, so that the operator's hand performs the whole fixing operation in one single hand movement.

9. “Fixing Device for Command Cable Terminals” of claim 1, wherein a safety lock solidary to the manopla is self-activated at the end of the operation to fix the command cable until fitting the pin of the internal terminal within the oblong hole of the safety lock.

10. “Fixing Device for Command Cable Terminals” of claim 1, wherein the external diametric surface of the end portion of the shaft, as well as the internal semidiametric surface of the internal terminal, are formed by multiple annular threads, with large retention capacity; and which, in the fixing position of the device, the surface threads of the shaft are fitted between the threads of the internal terminal, providing the shaft, solidary to the command cable, with highly resistant blocking.
